(19) United States
(12) Patent Application Publication
(10) Pub. No.: US 2024/0396886 A1
(43) Pub. Date: Nov. 28, 2024

(54) Migration From Legacy to Modern Token-Based Authentication Schemes

(71) Applicant: Cloud Software Group, Inc., Fort Lauderdale, FL (US)

(72) Inventors: Feng Huang, Cambridge (GB); John Ashman, Cambridge (GB)

(21) Appl. No.: 18/201,891

(22) Filed: May 25, 2023

(51) Int. Cl. H04L 9/40; G06F 9/54

(52) U.S. Cl. CPC H04L 63/083; G06F 9/547

(57) ABSTRACT

Methods and systems for transitioning between authentication schemes are described. A computing system may receive, from a user device and at an API gateway, an authorization token and an API call for a service, where the service may be configured with a legacy authentication scheme, and the authorization token may correspond to a new authentication scheme, different than the legacy authentication scheme. The computing system may obtain, using the authorization token and from an authorization server that generated the authorization token, a legacy token corresponding to the service and the legacy authentication scheme. The computing system may forward, along with the legacy token and to an API endpoint for the service, the API call. The computing system may receive, from the API endpoint for the service, an API response for the API call. The computing system may forward the API response to the user device.

### FIELD

Aspects described herein generally relate to computer networking, remote computer access, virtualization, enterprise mobility management, and hardware and software related thereto. More specifically, one or more aspects described herein include an API gateway configured to provide a progressive and non-disruptive transition from legacy to modern authentication schemes.

### BACKGROUND

In some instances, cloud service providers may have services that use different legacy token based authentication schemes. It may be desirable to provide a unified application programming interface (API) for these services and/or to adopt a modern authentication system. Doing so, for example, may simplify client software and increase adoption of APIs by customers and partners. It may be difficult, however, to maintain current clients while making the transition. For example, transitioning the authentication system may cause errors, delays, and/or otherwise create a negative client experience for customers possessing legacy authorization credentials, which might not, e.g., be compatible with the modern authentication system.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards improved transitioning from a legacy token based authentication scheme to an updated authentication scheme.

In one or more instances, a computing system comprising one or more processors, and memory storing computer executable instructions may receive, from a first user device and at an API gateway, a first authorization token and a first application programming interface (API) call for a first service, wherein the first service is configured with a legacy authentication scheme, and wherein the first authorization token corresponds to a new authentication scheme, different than the legacy authentication scheme. The computing system may obtain, using the first authorization token and from an authorization server that generated the first authorization token, a first legacy token corresponding to the first service and the legacy authentication scheme. The computing system may forward, along with the first legacy token and to an API endpoint for the first service, the first API call. The computing system may receive, from the API endpoint for the first service, a first API response for the first API call. The computing system may forward the first API response to the first user device.

In one or more instances, the computing system may receive, from a second user device and while the first service is configured with the legacy authentication scheme, a second API call for the first service and the first legacy token, where the second user device corresponds to a legacy user of the first service. The computing system may forward, along with the first legacy token and to the API endpoint for the first service, the second API call. The computing system may receive, from the API endpoint for the first service, a second API response for the second API call. The computing system may forward the second API response to the second user device.

In one or more instances, the first authorization token may include a reference to the first legacy token, and obtaining the first legacy token may include: sending, to the authorization server, the reference; and receiving, based on the reference, the first legacy token. In one or more instances, the first authorization token may include the first legacy token, and obtaining the first legacy token may include extracting, from the first authorization token, the first legacy token.

In one or more instances, obtaining the first legacy token may include: sending, to the authorization server and based on the first API request, an indication of the first service and the first authorization token; and receiving, from the authorization server, the first legacy token. In one or more instances, the first legacy token may be generated by the authorization server on demand and in response to receiving the indication of the first service and the first authorization token.

In one or more instances, the computing system may identify, based on a service configuration corresponding to the first service, that all legacy users of the first service have transitioned to the new authentication scheme. The computing system may cause, for the first service, a reconfiguration from the legacy authentication scheme to the new authentication scheme.

In one or more instances, the computing system may receive, from the first user device and after completion of the reconfiguration, a second API call for the first service and the first authorization token. The computing system may forward, to the API endpoint for the first service, the first authorization token. Based on validation of the first authorization token, the computing system may receive a second API response for the second API call. The computing system may forward the second API response to the first user device.

In one or more instances, the first authorization token may be configured for use in authenticating the first user device both during and after completion of the reconfiguration. In one or more instances, the API gateway may send, for a predetermined period of time after completion of the reconfiguration, both the first authorization token and the first legacy token, and authentication of the first user device may be performed using one of the first authorization token or the first legacy token.

In one or more instances, the computing system may identify, after completing the reconfiguration, that a second service has not completed the reconfiguration. The computing system may receive, a second API call for the second service and a second authorization token. The computing system may obtain, using the second authorization token and from the authorization server, a second legacy token corresponding to the second service and the legacy authentication scheme. The computing system may send, to an API endpoint for the second service, the second legacy token. Based on validation of the second legacy token, the computing system may receive a second API response for the second API call. The computing system may forward the second API response to the first user device.

In one or more instances, the computing system may receive, from the first user device and at the API gateway, the first authorization token and a second API call for a second service, wherein the second service is configured with the new authentication scheme. The computing system may forward, along with the first authorization token and to an API endpoint for the second service, the second API call. The computing system may receive, from the API endpoint for the second service, a second API response for the second API call. The computing system may forward the second API response to the first user device.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIGS. 5A-5C depict an illustrative computing environment for transitioning from a legacy token based authentication scheme to updated authentication schemes in accordance with one or more illustrative aspects described herein.

FIGS. 6A-6F depict an illustrative event sequence for transitioning from a legacy token based authentication scheme to updated authentication schemes in accordance with one or more illustrative aspects described herein.

FIG. 7 depicts an illustrative method for transitioning from a legacy token based authentication scheme to updated authentication schemes in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards migration from an older or legacy token based authentication scheme to a newer authentication scheme. Cloud service providers have services that use different legacy token based authentication schemes for different services. It may be desirable to provide a unified application programming interface (API) for these services and to adopt a newer, modern standard authentication system. This may simplify the client software and increase adoption of the APIs by customers and partners, while increasing security by using newer security standards. A challenge, however, may be to keep the current clients and services going while making the transition. The transition should therefore be progressive and should not disrupt existing clients and services.

New clients may access these services using the newer or modernized authentication scheme with a seamless single sign-on experience. Legacy clients may continue to work with existing services with legacy authentication schemes. When legacy clients are phased out, services may adopt the modernized authentication scheme at their own pace without a significant change at the same time.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned.” “engaged” and similar terms, is meant to include both direct and indirect mounting, connecting, coupling, positioning and engaging.

### Computing Architecture

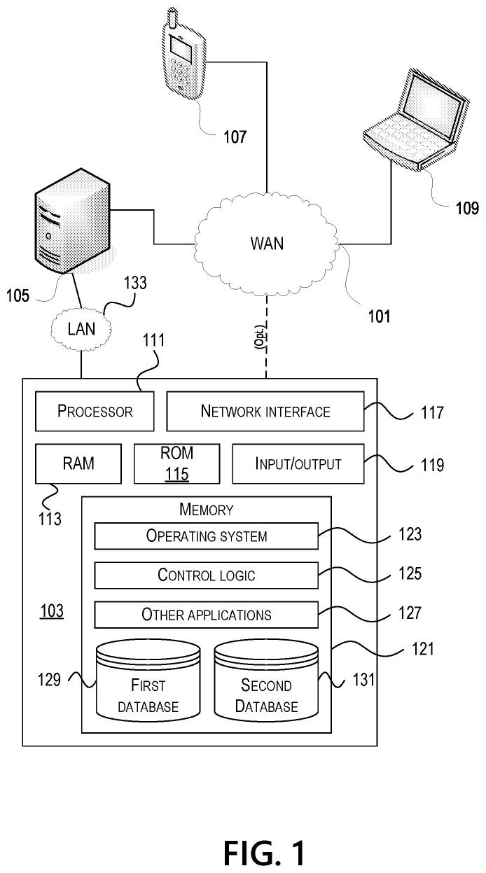

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network.” which is comprised of the data-attributable to a single entity-which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (V/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

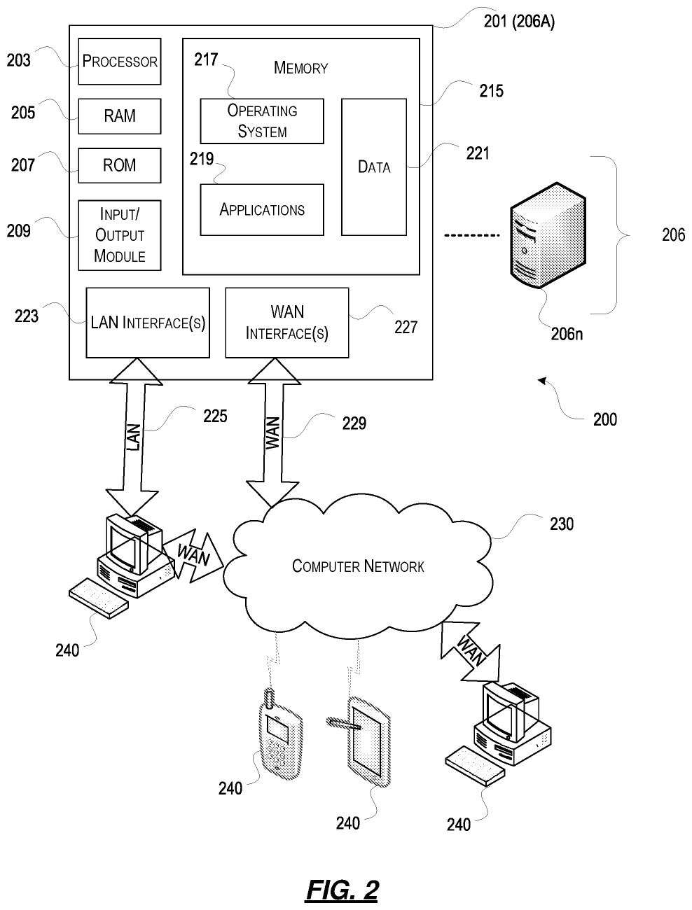

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

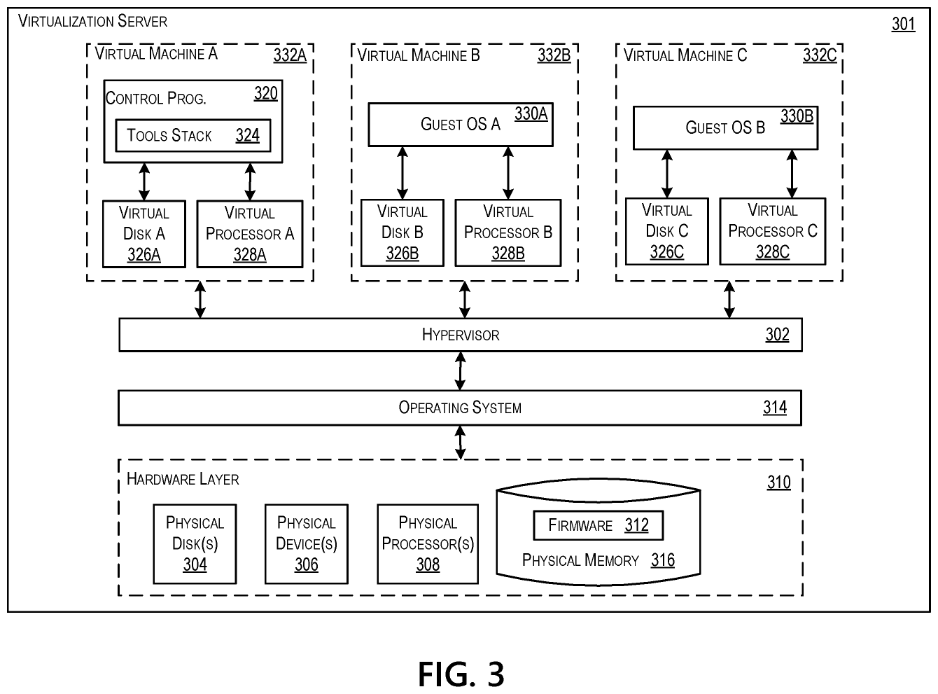

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

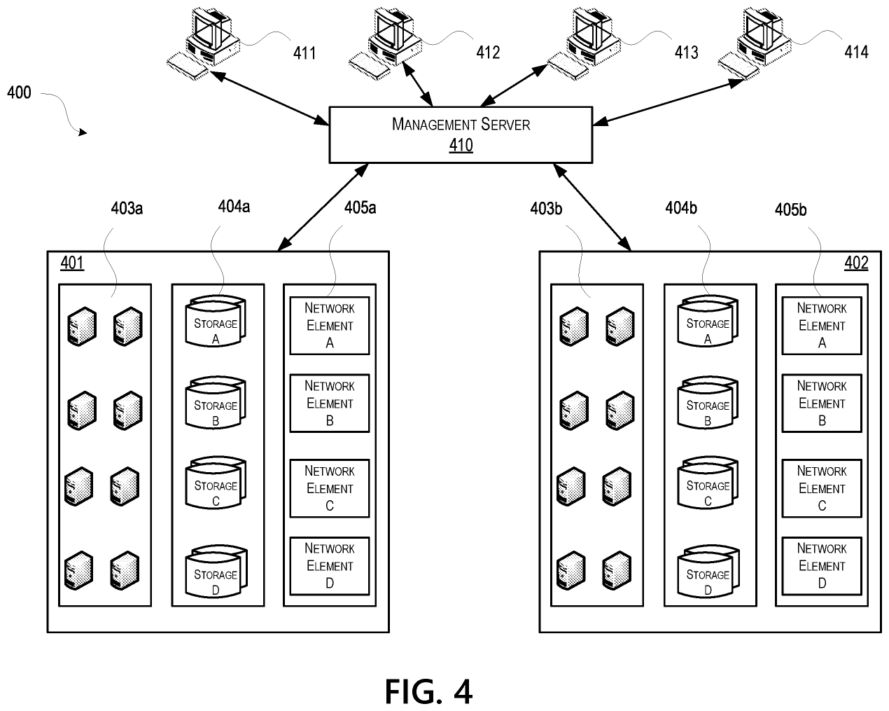

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

Improved Migration from Legacy to Modern Token-Based Authentication Schemes

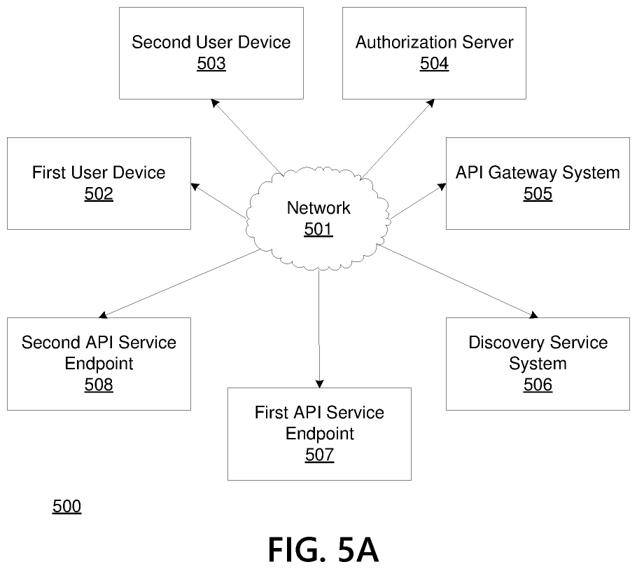

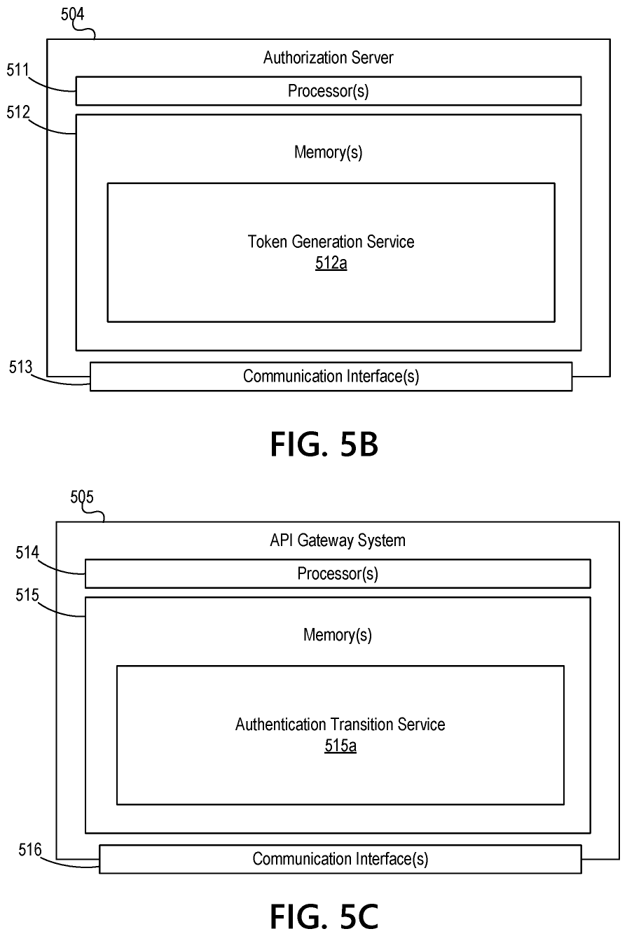

FIGS. 5A-5C depict an illustrative computing environment for improved migration from legacy to modern authentication schemes in accordance with one or more example embodiments. Referring to FIG. 3A, computing environment 500 may include one or more computer systems. For example, computing environment 500 may include first user device 502, second user device 503, authorization server 504, API gateway system 505, discovery service system 506, first API service endpoint 507, and second API service endpoint 508.

First user device 502 (which may, e.g., be a computing device similar to devices 107 or 109, shown in FIG. 1, or client machine 240, shown in FIG. 2) may include one or more computing devices configured to perform one or more of the functions described herein. For example, first user device 502 may be a laptop computer, desktop computer, mobile device, a tablet, a smart phone, and/or other device configured to send API requests. In some instances, the first user device 502 may be used by a new user (e.g., in contrast to a legacy user) of an API service. In these instances, the first user device 502 may be configured to store an authorization token corresponding to a new authentication scheme for the API service (e.g., in contrast to a legacy authentication scheme). In some instances, the first user device 502 may be configured to display one or more graphical user interfaces (e.g., authentication interfaces, response interfaces, or the like).

Second user device 503 (which may, e.g., be a computing device similar to devices 107 or 109, shown in FIG. 1, or client machine 240, shown in FIG. 2) may include one or more computing devices configured to perform one or more of the functions described herein. For example, second user device 503 may be a laptop computer, desktop computer, mobile device, a tablet, a smart phone, and/or other device configured to send API requests. In some instances, the second user device 503 may be used by a legacy user (e.g., in contrast to a new user, as is described above with regard to the first user device 502) of an API service. In these instances, the second user device 503 may be configured to store an authorization token corresponding to a legacy authentication scheme for the API service (e.g., in contrast to the new authentication scheme as is described above with regard to the first user device 502). In some instances, the second user device 503 may be configured to display one or more graphical user interfaces (e.g., authentication interfaces, response interfaces, or the like).

Although two user devices are shown, this is for illustrative purposes only. Any number of user devices may be implemented without departing from the scope of the disclosure.

Authorization server 504 (which may be similar to web server 105 or data server 103, shown in FIG. 1, and/or computing device 201 or server 206, shown in FIG. 2), may be configured to authenticate and/or authorize users for accessing API services. For example, the authorization server 504 may be configured to authenticate users based on user credentials (e.g., usernames, passwords, and/or other credentials). In some instances, the authorization server 504 may be configured to generate authorization and/or retrieve legacy tokens (e.g., from a legacy authorization service) for use in authenticating to an API service, and to provide these tokens to a user device (e.g., first user device 502, second user device 503, and/or other user devices) and/or API gateway system 505.

As illustrated further below, API gateway system 505 (which may be similar to server 206 (shown in FIG. 2), virtualization server 301 (shown in FIG. 3), and/or other systems, may be configured to receive API requests and to process them accordingly. For example, the API gateway system 505 may be configured to communicate with the authorization server 504 to obtain, using reference information in an authorization token and/or the authorization token itself, a legacy token for use in authenticating to an API service endpoint. Furthermore, the API gateway system 505 may be configured to receive API response information, and route the information to a user device accordingly

Discovery service system 506 (which may be similar to web server 105 or data server 103, shown in FIG. 1, and/or computing device 201 or server 206, shown in FIG. 2), may be configured to perform discovery with regard to available API endpoints, and to inform user devices accordingly. For example, the discovery service system 506 may be configured to inform the user devices of a scope of authorization to request from the authorization server 504.

First API service endpoint 507 may be or include one or more computing devices and/or components, and may be configured to provide API responses for a first service (e.g., a storage service, a web application service, a files service, or the like) in response to receiving API requests for that first service. In some instances, the first API service endpoint 507 may be configured to send the API responses based on validation/authentication of a token corresponding to an authentication scheme (e.g., a legacy token, an authorization token, or the like).

Second API service endpoint 508 may be or include one or more computing devices and/or components, and may be configured to provide API responses for a second service in response to receiving API requests for that second service (e.g., a storage service, a web application service, a files service, or the like). In some instances, the second API service endpoint 508 may be configured to send the API responses based on validation/authentication of a token corresponding to an authentication scheme (e.g., a legacy token, an authorization token, or the like).

Although two API service endpoints are shown, this is for illustrative purposes only. Any number of such service endpoints may be implemented without departing from the scope of the disclosure.

Computing environment 500 may also include one or more networks, which may interconnect first user device 502, second user device 503, authorization server 504, API gateway system 505, discovery service system 506, first API service endpoint 507, and/or second API service endpoint 508. For example, computing environment 500 may include a network 501 (which may e.g., interconnect first user device 502, second user device 503, authorization server 504, API gateway system 505, discovery service system 506, first API service endpoint 507, and/or second API service endpoint 508). In some instances, the network 501 may be similar to computer network 230, which is shown in FIG. 2.

In one or more arrangements, first user device 502, second user device 503, authorization server 504, API gateway system 505, discovery service system 506, first API service endpoint 507, second API service endpoint 508, and/or the other systems included in computing environment 500 may be any type of computing device capable of supporting implementation of authentication schemes and transitions between such authentication schemes. For example, first user device 502, second user device 503, authorization server 504, API gateway system 505, discovery service system 506, first API service endpoint 507, or second API service endpoint 508, and/or the other systems included in computing environment 500 may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of first user device 502, second user device 503, authorization server 504, API gateway system 505, discovery service system 506, first API service endpoint 507, or second API service endpoint 508 may, in some instances, be special purpose computing devices configured to perform specific functions.

Referring to FIG. 5B, authorization server 504 may include one or more processors 511, memory 512, and communication interface 513. A data bus may interconnect processor 511, memory 512, and communication interface 513. Communication interface 513 may be a network interface configured to support communication between authorization server 504 and one or more networks (e.g., network 501, or the like). Memory 512 may include one or more program modules having instructions that when executed by processor 511 may cause authorization server 504 to perform one or more functions described herein and/or access one or more databases that may store and/or otherwise maintain information which may be used by such program modules and/or processor 511. In some instances, the one or more program modules and/or databases may be stored by and/or maintained in different memory units of authorization server 504. For example, authorization server 504 may have, host, store, and/or include a token generation service 512a, which may be configured to generate and transmit tokens (for both legacy and/or new updated authentication schemes) for use in authenticating to API services.

Referring to FIG. 5C, API gateway system 505 may include one or more processors 514, memory 515, and communication interface 516. A data bus may interconnect processor 514, memory 515, and communication interface 516. Communication interface 516 may be a network interface configured to support communication between the API gateway system 505 and one or more networks (e.g., network 501, or the like). Memory 515 may include one or more program modules having instructions that when executed by processor 513 cause API gateway system 505 to perform one or more functions described herein and/or access one or more databases that may store and/or otherwise maintain information which may be used by such program modules and/or processor 514. In some instances, the one or more program modules and/or databases may be stored by and/or maintained in different memory units of API gateway system 505. For example, API gateway system 505 may have, host, store, and/or include an authentication transition service 515a, which may be configured to receive authorization tokens along with various API requests, identify corresponding legacy tokens, and forward the API requests, along with the identified legacy tokens, for processing at the corresponding endpoints.

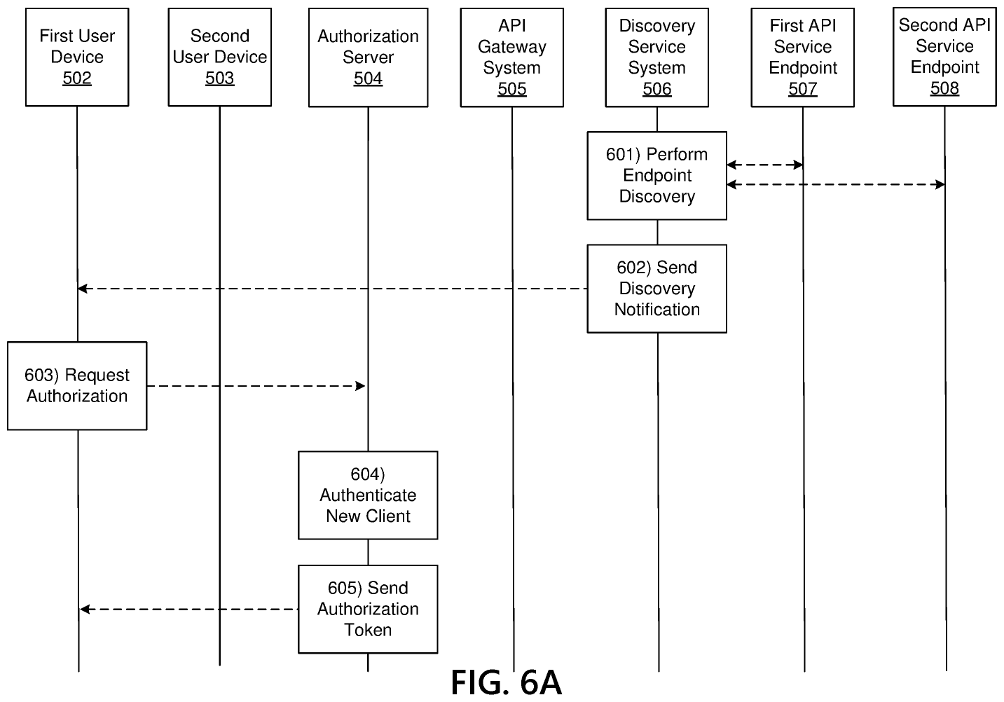

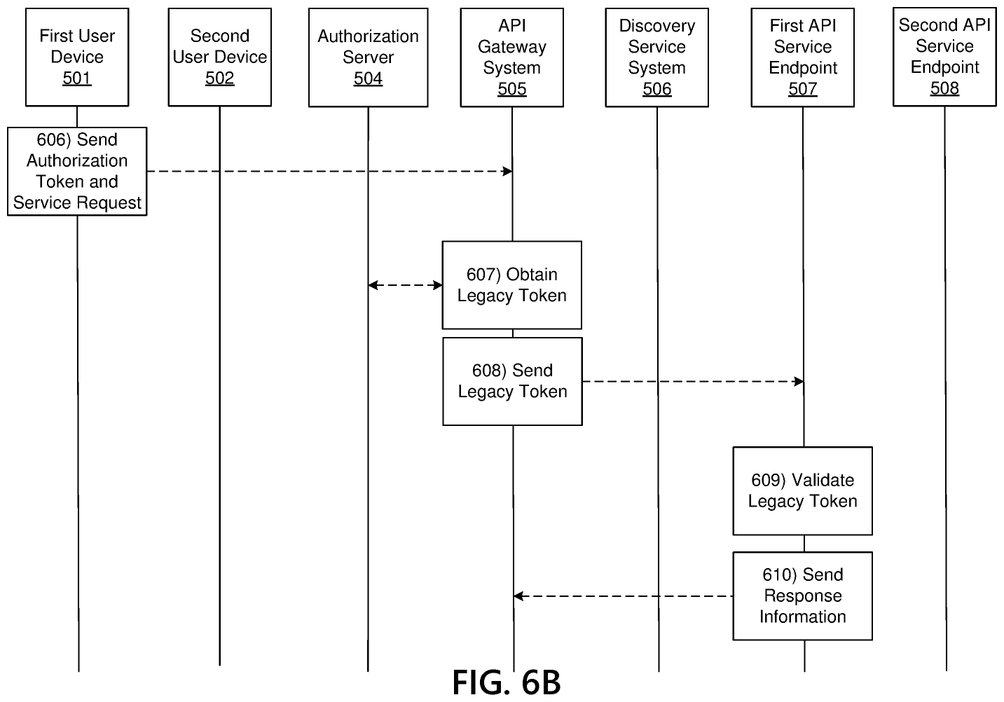

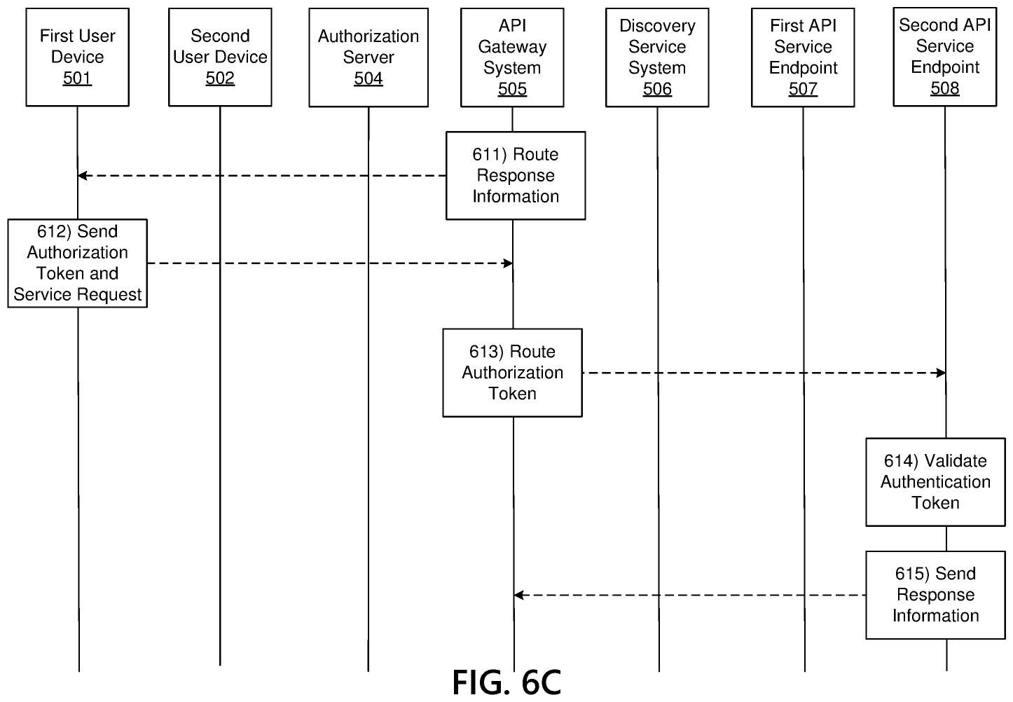

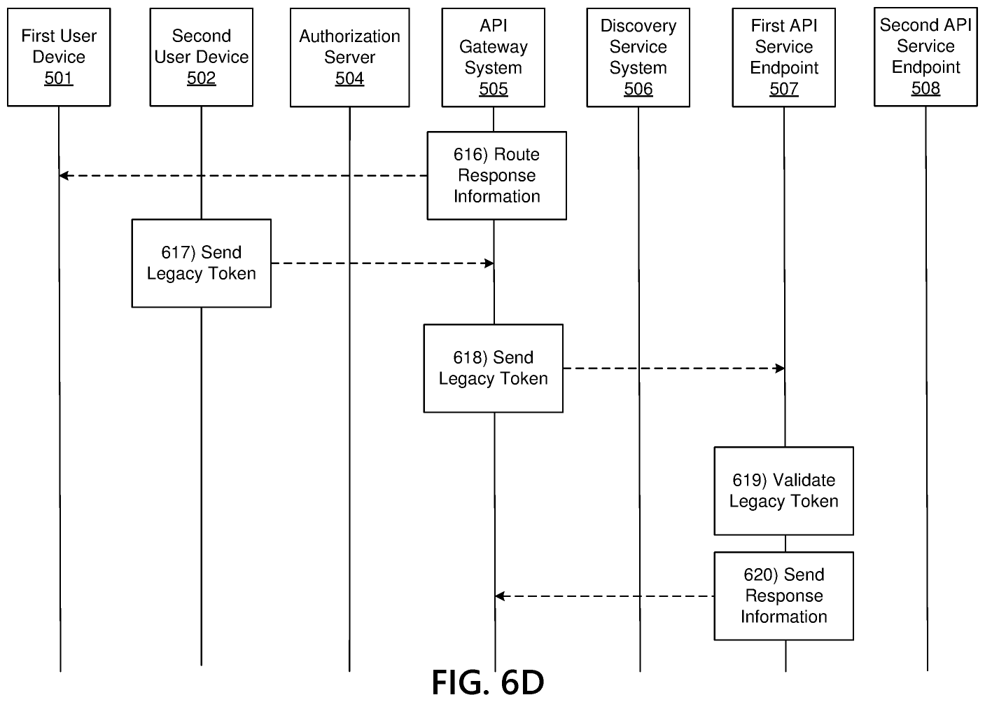

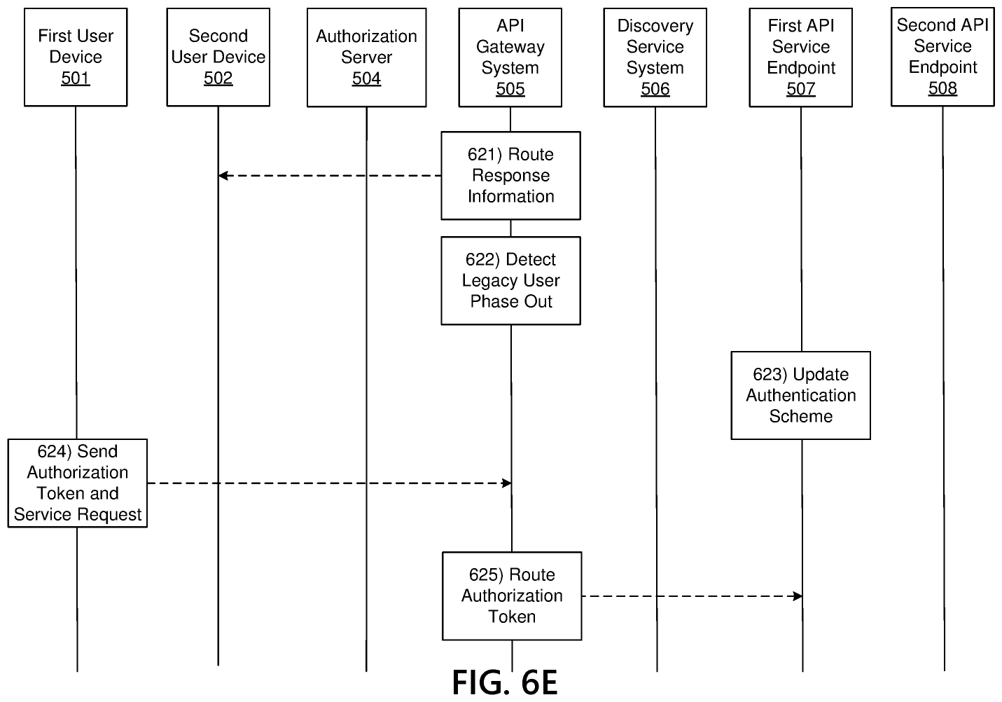

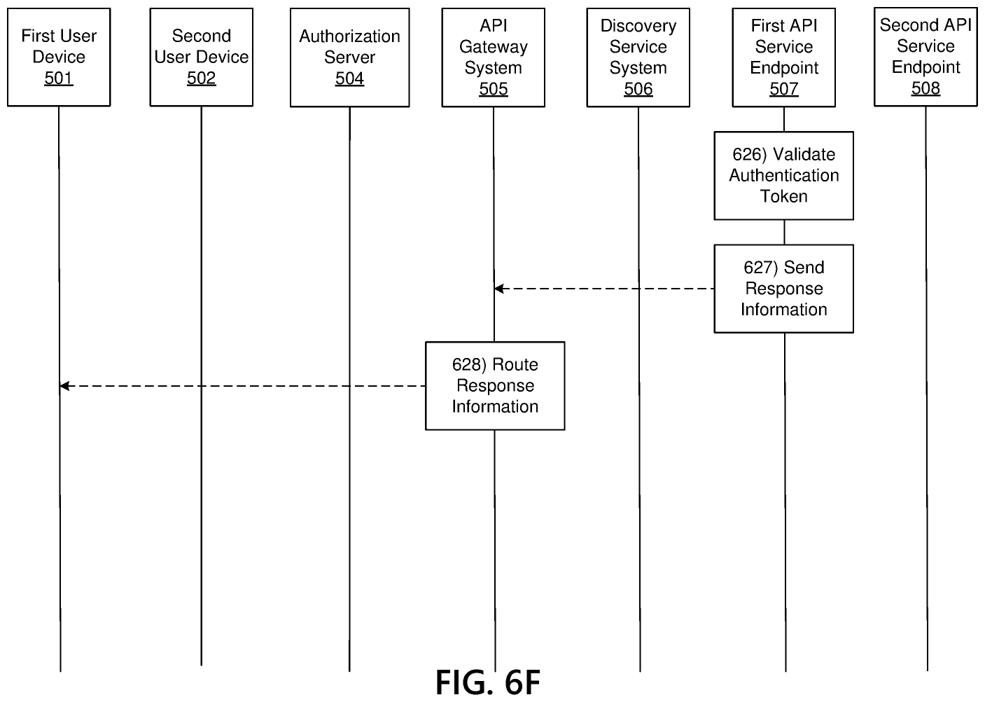

FIGS. 6A-6F depict an illustrative event sequence for improved migration from legacy to modern authentication schemes in accordance with one or more example embodiments. It should be understood that steps 601-628 may, in some instances, occur in the order as shown with regard to FIGS. 6A-6F. For example, after completing step 605 of FIG. 6A, the event sequence may proceed to step 606 of FIG. 6B.

Referring to FIG. 6A, at step 601, the discovery service system 506 may communicate with the first API service endpoint 507 and/or the second API service endpoint 508 so as to detect a presence of the first API service endpoint 507 and/or the second API service endpoint 508. At step 602, the discovery service system 506 may send a discovery document to the first user device 502, which may, e.g., inform the first user device 502 of available service endpoints for which authorization may be obtained. In some instances, rather than sending the discovery notification to the first user device 502, the discovery service system 506 may communicate with the first user device 502 via the API gateway system 505. In some instances, the discovery document may include authorization endpoints, API uniform resource locators (URL), related authentication scheme scopes, and/or other information for the service endpoints discovered at step 601.

At step 603, the first user device 502 may request authorization from the authorization server 504. For example, the first user device 502 may request authorization to access services provided by the first API service endpoint 507 and/or the second API service endpoint 508 (and/or other services identified in the discovery notification). In some instances, the first user device 502 may request authorization from the authorization server 504 after requesting access to one or more endpoints from the API gateway system 505 and receiving a response (e.g., from the API gateway system 505) indicating that authorization should be obtained from the authorization server 504. In other instances, the first user device 502 may request authorization from the authorization server 504 without prompting from the API gateway system 505. In some instances, the first user device 502 may send, along with the authorization request, an indication of one or more services for which authorization is requested, credentials (e.g., username, password, code, key, and/or other credentials), and/or other information. In these instances, the first user device 502 may request authorization because the first user device 502 might not have access to the first API service endpoint 507 and/or the second API service endpoint 508 through a legacy authentication scheme (e.g., may effectively be a new user).

At step 604, the authorization server 504 may authenticate the first user device 502 (and/or a first user of the first user device 502) based on the credentials provided at step 603. In some instances, the first user may be authenticated for all potential scopes (e.g., to obtain access to a plurality of available services) at the same time. In instances where the authorization server 504 successfully authenticates the first user device 502 and/or first user, the authorization server 504 may proceed to step 605. In other instances, the authorization server 504 may send a message to the first user device 502, which may, e.g., indicate that authentication was unsuccessful and that access is denied.

At step 605, the authorization server 504 may generate one or more authorization tokens. In some instances, the authorization server 504 may generate a different authorization token for each requested service (e.g., a first authorization token for the first API service endpoint 507, a second authorization token for the second API service endpoint 508, or the like). In some instances, the authorization server 504 may generate authorization tokens specific to the first user. In other instances, the authorization server 504 may generate authorization tokens specific to the service endpoints, but which might not be specific to the first user. In some instances, because the first user is authenticated for all potential scopes, the one or more authorization tokens may be sufficient for the first user to access all available services. This may avoid a need for the first user to request tokens for different scopes multiple times, which may result in communications between the first user device 502 and the authorization server 504.

In generating the authorization tokens, the authorization server 504 may generate authorization tokens compliant with a new authentication scheme for the first API service endpoint 507 and/or the second API service endpoint 508. For example, both the services supported by both endpoints may currently be supported by a legacy authentication scheme, and there may be a rollout/transition period during which there is a goal to transition from the legacy authentication schemes to the new authentication schemes. Accordingly, rather than providing legacy tokens to the first user device 502, which may become obsolete once the transition to the new authentication scheme is completed, the authorization server 504 may provide the authorization tokens despite the continued implementation of the legacy authentication scheme.

In some instances, in generating the one or more authorization tokens, the authorization server 504 may obtain (e.g., from a legacy authorization service) corresponding legacy tokens, which may, e.g., be compliant with the legacy authentication scheme. For example, if an authorization token for the first API service endpoint 507 is generated, a legacy token for the first API service endpoint 507 may similarly be obtained. In some instances, the legacy token may be obtained at substantially the same time as the corresponding authorization token. In other instances, the legacy token may be obtained on-demand upon receiving a request from the API gateway system 505 (as is described further below with regard to steps 607/608). The first user device 502 may receive the one or more authorization tokens and store them for subsequent use.

Referring to FIG. 6B, at step 606, the first user device 502 may send a first service request (e.g., an API call) for the first API service to the API gateway system 505. In these instances, the first user device 502 may also send, along with the service request, the corresponding authorization token (received at step 605). In some instances, the API gateway system 505 may validate the authorization token upon receipt (e.g., to ensure that it provides authorization for the relevant service), and may only proceed to step 607 in instances where the authorization token is validated.

At step 607, the API gateway system 505 may obtain the legacy token corresponding to the first service. In some instances, the API gateway system 505 may identify, a reference embedded into and/or otherwise included in the authorization token, and may send the reference to the authorization server 504. In these instances, the API gateway system 505 may send a message that includes the reference, and the authorization server 504 may identify, using the reference, the corresponding legacy token for the first service. In some instances, there may be a single reference to obtain a plurality of different legacy tokens (e.g., for different services) at the same time. Alternatively, there may be a different reference for each legacy token (e.g., for each service).

Additionally or alternatively, the API gateway system 505 may send the authorization token itself to the authorization server 504. For example, the API gateway system 505 may send the authorization server 504 using a token exchange flow. In these instances, the authorization token might not include a reference to the corresponding legacy token, but the API gateway system 505 may request a legacy token corresponding to the requested service (e.g., the first service), and may effectively exchange the authorization token for the legacy token. In some instances, this may simplify a logic for the API gateway system 505, as it might not need to understand the token references. As an additional advantage, in these instances, the authorization server 504 need not include any references in the authorization tokens. In either instance, communication between the API gateway system 505 and the authorization server 504 may be protected by service-to-service authentication.

In either instance, the authorization server 504 may identify the corresponding legacy token, and may provide the legacy token to the API gateway system 505. In some instances, the authorization server 504 may have pre-generated the legacy token. For example, the authorization server 504 may have generated the legacy token at substantially the same time as the authorization token. Alternatively, the authorization server 504 may generate the legacy token on demand (e.g., in response to receiving the request from the API gateway system 505). In some instances, once the API gateway system 505 receives the legacy token from the authorization server 504, it may cache the legacy token. In doing so, the API gateway system 505 may only need to request the legacy token for the first service a single time. In some instances, the legacy token may be specific to the first service, but may be user agnostic. Accordingly, the API gateway system 505 may be able to use the same legacy token for any requests to access the first service. In other instances, the legacy token may be specific to both the first service and the first user, and thus the API gateway system 505 may only be able to use the legacy token to request access to the first service on behalf of the first user.

As an alternative to obtaining the legacy token from the authorization server 504, the API gateway system 505 may obtain the legacy token from the authorization token itself. For example, in generating the authorization token at step 605, the authorization server 504 may have embedded and/or otherwise included the corresponding legacy tokens in the authorization token, and subsequently sent the authorization token to the first user device 502. Accordingly, in these instances, the authorization token may contain the corresponding legacy token(s), and thus the API gateway system 505 may obtain the legacy token from the authorization token without reaching out to the authorization server 504 as is described in the above examples.

At step 608, the API gateway system 505 may send the legacy token (rather than the authorization token) to the first API service endpoint 507. In these instances, the API gateway system 505 may forward the first service request to the first API service endpoint 507 along with the legacy token.

At step 609, the first API service endpoint 507 may validate the legacy token received at step 608. For example, the first API service endpoint 507 may validate the legacy token using the legacy authentication scheme. In instances where the legacy token is not valid, the first API service endpoint 507 may deny service (e.g., send a notification denying the service, or the like). In instances where the legacy token is valid, the first API service endpoint 507 may proceed to step 610. At step 610, the first API service endpoint 507 may identify response information (e.g., an API response), and may send the response information to the API gateway system 505.

Referring to FIG. 6C, at step 611, the API gateway system 505 may route/forward the response information to the first user device 502. At step 612, the first user device 502 may send the authorization token and a service request to the API gateway system 505. For example, the first user device 502 may perform similar actions as those described above with regard to step 606. In these instances, however, the service request may be a request directed to the second API service endpoint 508 rather than the first API service endpoint 507. For example, although the first API service endpoint 507 may be continuing with implementation of the legacy authentication scheme (e.g., due to the existence of one or more legacy users), the second API service endpoint 508 may be implementing the new authentication scheme (e.g., as the transition from the legacy to the new authentication scheme may occur on a service by service basis, thus resulting in some services that continue to implement the legacy authentication scheme while others implement the new authentication scheme). Nevertheless, the authorization token sent at step 612 may be the same authentication token sent at step 606. For example, as the first user device 502 was already provided with an authorization token compliant with the new authentication scheme (e.g., the authorization token), it may provide the same authorization token both during and after completion of the transition from the legacy to the new authentication scheme, and accordingly, may be used to authenticate with both the first API service endpoint 507 (implementing the legacy authentication scheme) and the second API service endpoint 508 (implementing the new authentication scheme).

At step 613, the API gateway system 505 may route the authorization token, received at step 612, to the second API endpoint 508. For example, because the second API service endpoint 508 may be implementing the new authentication scheme rather than the legacy authentication scheme, rather than providing a legacy token to the second API service endpoint 508 (as is described above with regard to steps 607/608 in relation to the first API service endpoint 507), the API gateway system 505 may provide the authorization token itself to the second API service endpoint 508.

In some instances, rather than sending the authorization token to the second API service endpoint 508 via the API gateway system 505, the first user device 502 may send the authorization token and/or service request directly to the second API service endpoint 508.

At step 614, the second API service endpoint 508 may validate the authorization token using the new authentication scheme. For example, the second API service endpoint 508 may validate the authorization token using similar techniques to those described above with regard to the legacy token/legacy authentication scheme at step 609.

At step 615, the second API service endpoint 508 may send response information to the API gateway system 505. For example, the second API service endpoint 508 may perform actions similar to those performed by the first API service endpoint 507 and described above with regard to step 610.

Referring to FIG. 6D, at step 616, the API gateway system 505 may route the response information to the first user device 502. For example, the API gateway system 505 may perform actions similar to those described above with regard to step 611. In some instances, rather than sending the response information to the first user device 502 via the API gateway system 505, the second API service endpoint 508 may send the response information directly to the first user device 502.

Accordingly, although the first API service endpoint 507 has not completed a transition from the legacy authentication scheme to the new authentication scheme, but the second API service endpoint 508 has completed the transition, the same authorization token may be used to authenticate the first user device 501 to either service (e.g., in contrast to the use of multiple different tokens such as a legacy token for the first service and a new authentication token for the second service).

While steps 601-616 describe a new user of the first/second services, steps 617-621 describe a legacy user of the first service. For example, a legacy user, such as a user of the second user device 503, may have enrolled and/or otherwise received authentication credentials for the first service prior to an introduction of the new authentication scheme. Accordingly, they may possess a legacy token corresponding to a legacy authentication scheme for the first service.

At step 617, the second user device 503, which may e.g., correspond to a legacy or second user of the first service, may send a legacy token to the API gateway system 505. As described above with regard to step 607, in some instances, the legacy token may be user agnostic, and thus, may in some instances, be the same legacy token obtained by the API gateway system 505 for the first user at step 607. In other instances, the legacy token may be user specific, and thus may be a different legacy token than the one described above with regard to step 607. In either instance, the legacy token may be specific to the first service, and may corresponding to a legacy authentication scheme of the first service. In some instances, the legacy token may have been provided to the second user device 503 at some point in the past during which the legacy authentication scheme was implemented for the first service.

At step 618, the API gateway system 505 may forward the legacy token to the first API service endpoint 507. For example, rather than communicating with the authorization server 504 to obtain a different token as is described above with regard to step 607, the API gateway system 505 may simply forward the legacy token on (as the first API service endpoint 507 may still be implementing the legacy authentication scheme). In some instances, rather than sending the legacy token to the first API service endpoint 507 via the API gateway system 505, the second user device 503 may send the legacy token directly to the first API service endpoint 507.

At step 619, the first API service endpoint 507 may validate the legacy token. For example, the first API service endpoint 507 may perform similar actions to those described above with regard to step 609.

At step 620, the first API service endpoint 507 may send response information to the API gateway system 505. For example, the first API service endpoint 507 may perform similar actions to those described above with regard to step 610.

Referring to FIG. 6E, at step 621, the API gateway system 505 may route/forward the response information, received at step 620, to the second user device 503. For example, the first API service endpoint 507 may perform similar actions to those described above at step 611 with regard to forwarding of the response information to the first user device 502. In some instances, rather than providing the response information to the second user device 503 via the API gateway system 505, the first API service endpoint 507 may send the response information directly to the second user device 503.

By operating in this way, new users of the first service, such as the first user, may be onboarded with a token (e.g., the authorization token) corresponding to the new authentication scheme, but the first service may continue to implement a legacy authentication scheme. Accordingly, legacy users of the first service may continue to use their legacy credentials to access the first service. This may enable a transition from the legacy authentication scheme to the new authentication scheme that may be smooth and seamless from the perspective of both new and legacy users.

At step 622, the API gateway system 505 may detect that all legacy users of the first service have phased out. For example, the API gateway system 505 may detect that all legacy users have obtained authorization tokens compliant with the new authentication scheme, terminated their access to the first service, experienced an expiration of their legacy tokens, and/or otherwise eliminated their need for the use of a legacy authentication scheme for the first service. In some instances, the API gateway system 505 may perform such detection based on a service configuration corresponding to the first service. In some instances, in addition or as an alternative to the detection of the legacy user phase out by the API gateway system 505, the first API service endpoint 507 may perform the detection as described above.

At step 623, the first API service endpoint 507 may transition, reconfigure, and/or otherwise update the first service from the legacy authentication scheme to the new authentication scheme. For example, the first API service endpoint 507 may update the authentication scheme based on a message from the API gateway system 505, which may indicate that there are no remaining legacy users for the first API service endpoint 507. In these instances, the API gateway system 505 may effectively cause or otherwise trigger the reconfiguration of the authentication scheme. In completing the transition from the legacy authentication scheme to the new authentication scheme, the first API service endpoint 507 may configure itself to validate authorization tokens (such as the authorization token) rather than legacy tokens.

This phase described by steps 601-623 may be referred to as a client transition phase, during which existing clients (e.g., the legacy user) may access services (e.g., the first service) using their legacy tokens whereas new clients (e.g., the new/first user) may use their authorization tokens. In doing so, both new and legacy clients may be supported without any disruption.

While steps 601-623 describe operation during the transition period from the legacy authentication scheme to the new authentication scheme (e.g., the client transition phase) for the first service, steps 624-628 refer to operation once the transition to the new authentication scheme (e.g., occurring at step 623) has completed. For example, once the client transition phase completes, legacy clients might no longer be supported and backend services may be modernized to consume authorization tokens issued by the authorization server 504 (e.g., rather than the legacy tokens). In some instances, this may be performed on a service by service basis.

At step 624, the first user device 502 may send the authorization token and a service request to the API gateway system 505. For example, the first user device 502 may perform similar actions as those described above with regard to step 606. As the first user device 502 was already provided with an authorization token compliant with the new authentication scheme (e.g., the authorization token), it may provide the same authorization token both during and after completion of the transition from the legacy to the new authentication scheme. This may, for example, avoid a need for the first user device 502 to reauthenticate with the authorization server 504 to obtain an updated authorization token once the new authentications scheme is implemented.

At step 625, the API gateway system 505 may route the authorization token, received at step 624, to the first API service endpoint 507. For example, now that a transition from the legacy authentication scheme to the new authentication scheme is completed for the first API service endpoint 507, rather than providing a legacy token to the first API service endpoint 507 (as is described above with regard to steps 607/608), the API gateway system 505 may provide the authorization token itself.

In some instances, there may be a predetermined period of time during which the API gateway system 505 continues to obtain/send legacy tokens to the first API service endpoint 507 as described above with regard to steps 607/608. For example, the API gateway system 505 may send both the authorization token and the legacy token to the first API service endpoint 507 during this period of time. In doing so, the API gateway system 505 may effectively create a roll out period, during which both tokens are provided so as to avoid any authentication and/or response errors with regard to one of them. Then, once the predetermined period of time has expired, the API gateway system 505 may send only the authorization token as described above.

In some instances, rather than sending the authorization token to the first API service endpoint 507 via the API gateway system 505, the first user device 502 may send the authorization token and/or service request directly to the first API service endpoint 507.

Referring to FIG. 6F, at step 626, the first API service endpoint 507 may validate the authorization token using the new authentication scheme. For example, the first API service endpoint 507 may validated the authorization token using similar techniques to those described above with regard to the legacy token/legacy authentication scheme at step 619.

At step 627, the first API service endpoint 507 may send response information to the API gateway system 505. For example, the first API service endpoint 507 may perform actions similar to those described above with regard to step 620.

At step 628, the API gateway system 505 may route the response information to the first user device 502. For example, the API gateway system 505 may perform actions similar to those described above with regard to step 621. In some instances, rather than sending the response information to the first user device 502 via the API gateway system 505, the first API service endpoint 507 may send the response information directly to the first user device 502.

As described above with regard to steps 624-628, once a transition from the legacy authentication scheme to the new authentication scheme is complete, the authorization tokens may be used to authenticate to the first service rather than the legacy tokens. Such transitions, however, may occur on a service by service basis, and thus while the transition may be complete for the first service, it might not be complete for a second service (e.g., corresponding to the second API service endpoint 508). Accordingly, in these instances, the API gateway system 505 may continue to obtain legacy tokens corresponding to authorization tokens for requests directed to the second service, despite no longer doing so for the first service.

By operating in this way, new clients (e.g., the first user) may access services using the new authentication scheme with a single sign-on experience. For example, they might not need to request a specific or delegated token that may need to be updated once the new authentication scheme is implemented. Legacy clients (e.g., the second user), however, may continue to use the legacy authentication scheme for existing services. Then, as legacy clients are phased out, services may adopt the new authentication scheme (e.g., as described above with regard to the first service) at their own pace, and without a sudden mandatory transition. This process may continue until all services have migrated to the new authentication scheme, at which point requests from all services may be handled under the new authentication scheme.

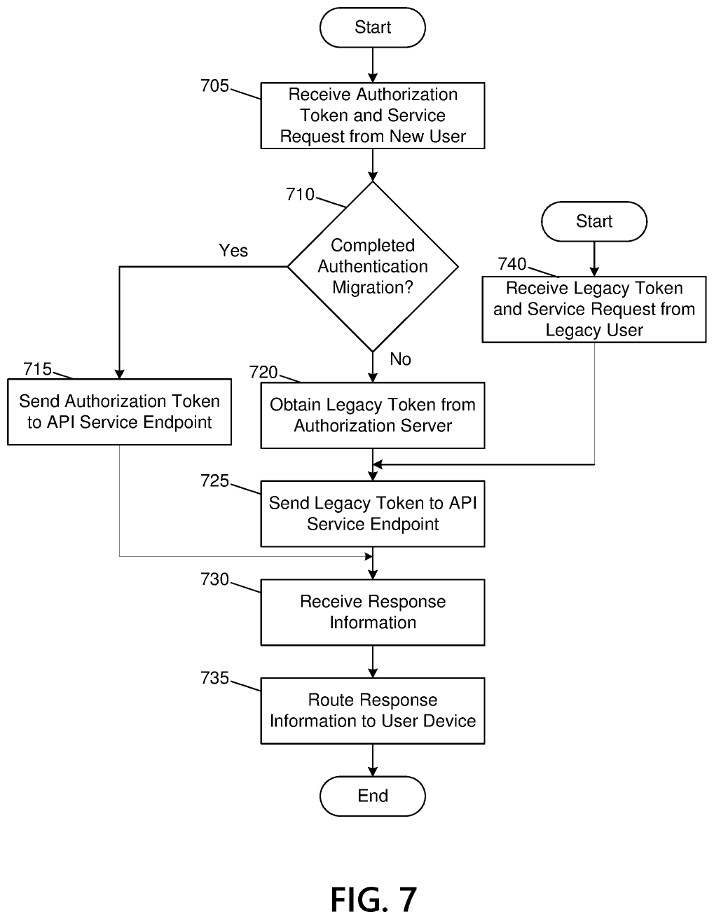

FIG. 7 depicts an illustrative method for improved migration from legacy to modern authentication schemes in accordance with one or more example embodiments. Referring to FIG. 7, at step 705, a computing system comprising a memory and one or more processors may receive an authorization token and a service request from a new user. At step 710, the computing system may identify whether or not a migration from a legacy authentication scheme to a new authentication scheme is complete. If the migration is not complete, the computing system may proceed to step 720.

At step 720, the computing system may obtain a legacy token, corresponding to the authorization token, from an authorization server or from the authorization token itself. At step 725, the computing system may send the legacy token to an API service endpoint corresponding to the service request. At step 730, the computing system may receive response information from the API service endpoint. At step 735, the computing system may route the response information to a user device that sent the service request.

Referring back to step 710, if the computing system identifies that the migration from the legacy authentication scheme to the new authentication scheme is complete, the computing system may proceed to step 715. At step 715, the computing system may send the authorization token (e.g., rather than the legacy token as described above with regard to step 720) to the API service endpoint. The computing system may then proceed to steps 730/735 to receive and route response information and described above.

Returning to the start of the method, at step 740, the computing system may receive a legacy token and a service request from a legacy user (e.g., rather than the authorization token received from the new user at step 705). In these instances, the computing system may proceed to steps 725-735 to send the legacy token to the API service endpoint, and to receive/route response information accordingly.

The following paragraphs (M1) through (M12) describe examples of methods that may be implemented in accordance with the present disclosure.

(M1) A method comprising: receiving, from a first user device and at an API gateway, a first authorization token and a first application programming interface (API) call for a first service, wherein the first service is configured with a legacy authentication scheme, and wherein the first authorization token corresponds to a new authentication scheme, different than the legacy authentication scheme; obtaining, using the first authorization token and from an authorization server that generated the first authorization token, a first legacy token corresponding to the first service and the legacy authentication scheme; forwarding, along with the first legacy token and to an API endpoint for the first service, the first API call; receiving, from the API endpoint for the first service, a first API response for the first API call; and forwarding the first API response to the first user device.

(M2) A method may be performed as described in paragraph (M1), further comprising: receiving, from a second user device and while the first service is configured with the legacy authentication scheme, a second API call for the first service and the first legacy token, wherein the second user device corresponds to a legacy user of the first service; forwarding, along with the first legacy token and to the API endpoint for the first service, the second API call; receiving, from the API endpoint for the first service, a second API response for the second API call; and forwarding the second API response to the second user device.

(M3) A method may be performed as described in any of paragraphs (M1) or (M2), wherein the first authorization token includes a reference to the first legacy token, and wherein obtaining the first legacy token comprises: sending, to the authorization server, the reference; and receiving, based on the reference, the first legacy token.

(M4) A method may be performed as described in any of paragraphs (M1) through (M3), wherein the first authorization token includes the first legacy token, and wherein obtaining the first legacy token comprises extracting, from the first authorization token, the first legacy token.

(M5) A method may be performed as described in any of paragraphs (M1) through (M4), wherein obtaining the first legacy token comprises: sending, to the authorization server and based on the first API request, an indication of the first service and the first authorization token; and receiving, from the authorization server, the first legacy token.

(M6) A method may be performed as described in paragraph (M5), wherein the first legacy token is generated by the authorization server on demand and in response to receiving the indication of the first service and the first authorization token.

(M7) A method may be performed as described in any of paragraphs (M1) through (M6) further comprising: identifying, based on a service configuration corresponding to the first service, that all legacy users of the first service have transitioned to the new authentication scheme; and causing, for the first service, a reconfiguration from the legacy authentication scheme to the new authentication scheme.

(M8) A method may be performed as described in paragraph (M7), further comprising: receiving, from the first user device and after completion of the reconfiguration, a second API call for the first service and the first authorization token; forwarding, to the API endpoint for the first service, the first authorization token; based on validation of the first authorization token, receiving a second API response for the second API call; and forwarding the second API response to the first user device.

(M9) A method may be performed as described in paragraph (M7), wherein the first authorization token is configured for use in authenticating the first user device both during and after completion of the reconfiguration.

(M10) A method may be performed as described in paragraph (M7), wherein the API gateway sends, for a predetermined period of time after completion of the reconfiguration, both the first authorization token and the first legacy token, and wherein authentication of the first user device is performed using one of the first authorization token or the first legacy token.

(M11) A method may be performed as described in paragraph (M7), further comprising: identifying, after completing the reconfiguration, that a second service has not completed the reconfiguration; receiving, a second API call for the second service and a second authorization token; obtaining, using the second authorization token and from the authorization server, a second legacy token corresponding to the second service and the legacy authentication scheme; sending, to an API endpoint for the second service, the second legacy token; based on validation of the second legacy token, receiving a second API response for the second API call; and forwarding the second API response to the first user device.

(M12) A method may be performed as described in any one of paragraphs (M1) through (M11), further comprising: receiving, from the first user device and at the API gateway, the first authorization token and a second API call for a second service, wherein the second service is configured with the new authentication scheme; forwarding, along with the first authorization token and to an API endpoint for the second service, the second API call; receiving, from the API endpoint for the second service, a second API response for the second API call; and forwarding the second API response to the first user device.

The following paragraphs (A1) through (A7) describe examples of apparatuses that may be implemented in accordance with the present disclosure.

(A1) A computing system comprising: one or more processors; memory storing computer executable instructions that, when executed by the processor, cause the computing system to: receive, from a first user device and at an API gateway, a first authorization token and a first application programming interface (API) call for a first service, wherein the first service is configured with a legacy authentication scheme, and wherein the first authorization token corresponds to a new authentication scheme, different than the legacy authentication scheme; obtain, using the first authorization token and from an authorization server that generated the first authorization token, a first legacy token corresponding to the first service and the legacy authentication scheme; forward, along with the first legacy token and to an API endpoint for the first service, the first API call; receive, from the API endpoint for the first service, a first API response for the first API call; and forward the first API response to the first user device.

(A2) A computing system as described in paragraph (A1) may receive, from a second user device and while the first service is configured with the legacy authentication scheme, a second API call for the first service and the first legacy token, wherein the second user device corresponds to a legacy user of the first service; forward, along with the first legacy token and to the API endpoint for the first service, the second API call; receive, from the API endpoint for the first service, a second API response for the second API call; and forward the second API response to the second user device.

(A3) A computing system as described in any of paragraphs (A1) or (A2), wherein the first authorization token includes a reference to the first legacy token, and wherein obtaining the first legacy token comprises: sending, to the authorization server, the reference; and receiving, based on the reference, the first legacy token.

(A4) A computing system as described in any of paragraphs (A1) through (A3), wherein the first authorization token includes the first legacy token, and wherein obtaining the first legacy token comprises extracting, from the first authorization token, the first legacy token.

(A5) A computing system as described in any of paragraphs (A1) through (A4), wherein obtaining the first legacy token comprises: sending, to the authorization server and based on the first API request, an indication of the first service and the first authorization token; and receiving, from the authorization server, the first legacy token.

(A6) A computing system as described in paragraph (A5), wherein the first legacy token is generated by the authorization server on demand and in response to receiving the indication of the first service and the first authorization token.

(A7) A computing system as described in any of paragraphs (A1) through (A6), wherein the memory stores additional computer readable instructions that, when executed by the one or more processors, cause the computing system to: identifying, based on a service configuration corresponding to the first service, that all legacy users of the first service have transitioned to the new authentication scheme; and causing, for the first service, a reconfiguration from the legacy authentication scheme to the new authentication scheme.

The following paragraph (CRM1) describes examples of computer-readable media that may be implemented in accordance with the present disclosure.

(CRM1) One or more non-transitory computer-readable media storing instructions that, when executed by a computing system comprising at least one processor, a communication interface, and memory, cause the computing system to: receive, from a first user device and at an API gateway, a first authorization token and a first application programming interface (API) call for a first service, wherein the first service is configured with a legacy authentication scheme, and wherein the first authorization token corresponds to a new authentication scheme, different than the legacy authentication scheme; obtain, using the first authorization token and from an authorization server that generated the first authorization token, a first legacy token corresponding to the first service and the legacy authentication scheme; forward, along with the first legacy token and to an API endpoint for the first service, the first API call; receive, from the API endpoint for the first service, a first API response for the first API call; and forward the first API response to the first user device.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, from a first user device and at an API gateway, a first authorization token and a first application programming interface (API) call for a first service, wherein the first service is configured with a legacy authentication scheme, and wherein the first authorization token corresponds to a new authentication scheme, different than the legacy authentication scheme;
obtaining, using the first authorization token and from an authorization server that generated the first authorization token, a first legacy token corresponding to the first service and the legacy authentication scheme;
forwarding, along with the first legacy token and to an API endpoint for the first service, the first API call;
receiving, from the API endpoint for the first service, a first API response for the first API call; and
forwarding the first API response to the first user device.

2. The method of claim 1, further comprising:
receiving, from a second user device and while the first service is configured with the legacy authentication scheme, a second API call for the first service and the first legacy token, wherein the second user device corresponds to a legacy user of the first service;
forwarding, along with the first legacy token and to the API endpoint for the first service, the second API call;
receiving, from the API endpoint for the first service, a second API response for the second API call; and
forwarding the second API response to the second user device.

3. The method of claim 1, wherein the first authorization token includes a reference to the first legacy token, and wherein obtaining the first legacy token comprises:
sending, to the authorization server, the reference; and
receiving, based on the reference, the first legacy token.

4. The method of claim 1, wherein the first authorization token includes the first legacy token, and wherein obtaining the first legacy token comprises extracting, from the first authorization token, the first legacy token.

5. The method of claim 1, wherein obtaining the first legacy token comprises:
sending, to the authorization server and based on the first API request, an indication of the first service and the first authorization token; and
receiving, from the authorization server, the first legacy token.

6. The method of claim 5, wherein the first legacy token is generated by the authorization server on demand and in response to receiving the indication of the first service and the first authorization token.

7. The method of claim 1, further comprising:
identifying, based on a service configuration corresponding to the first service, that all legacy users of the first service have transitioned to the new authentication scheme; and
causing, for the first service, a reconfiguration from the legacy authentication scheme to the new authentication scheme.

8. The method of claim 7, further comprising:
receiving, from the first user device and after completion of the reconfiguration, a second API call for the first service and the first authorization token;
forwarding, to the API endpoint for the first service, the first authorization token;
based on validation of the first authorization token, receiving a second API response for the second API call; and
forwarding the second API response to the first user device.

9. The method of claim 7, wherein the first authorization token is configured for use in authenticating the first user device both during and after completion of the reconfiguration.

10. The method of claim 7, wherein the API gateway sends, for a predetermined period of time after completion of the reconfiguration, both the first authorization token and the first legacy token, and wherein authentication of the first user device is performed using one of the first authorization token or the first legacy token.

11. The method of claim 7, further comprising:
identifying, after completing the reconfiguration, that a second service has not completed the reconfiguration;
receiving, a second API call for the second service and a second authorization token;
obtaining, using the second authorization token and from the authorization server, a second legacy token corresponding to the second service and the legacy authentication scheme;
sending, to an API endpoint for the second service, the second legacy token;
based on validation of the second legacy token, receiving a second API response for the second API call; and
forwarding the second API response to the first user device.

12. The method of claim 1, further comprising:
receiving, from the first user device and at the API gateway, the first authorization token and a second API call for a second service, wherein the second service is configured with the new authentication scheme;
forwarding, along with the first authorization token and to an API endpoint for the second service, the second API call;
receiving, from the API endpoint for the second service, a second API response for the second API call; and
forwarding the second API response to the first user device.

13. A computing system comprising:
one or more processors;
memory storing computer executable instructions that, when executed by the processor, cause the computing system to:
receive, from a first user device and at an API gateway, a first authorization token and a first application programming interface (API) call for a first service, wherein the first service is configured with a legacy authentication scheme, and wherein the first authorization token corresponds to a new authentication scheme, different than the legacy authentication scheme;
obtain, using the first authorization token and from an authorization server that generated the first authorization token, a first legacy token corresponding to the first service and the legacy authentication scheme;
forward, along with the first legacy token and to an API endpoint for the first service, the first API call;
receive, from the API endpoint for the first service, a first API response for the first API call; and
forward the first API response to the first user device.

14. The computing system of claim 13, wherein the memory stores additional computer readable instructions that, when executed by the one or more processors, cause the computing system to:
receive, from a second user device and while the first service is configured with the legacy authentication scheme, a second API call for the first service and the first legacy token, wherein the second user device corresponds to a legacy user of the first service;
forward, along with the first legacy token and to the API endpoint for the first service, the second API call;
receive, from the API endpoint for the first service, a second API response for the second API call; and
forward the second API response to the second user device.

15. The computing system of claim 13, wherein the first authorization token includes a reference to the first legacy token, and wherein obtaining the first legacy token comprises:
sending, to the authorization server, the reference; and
receiving, based on the reference, the first legacy token.

16. The computing system of claim 13, wherein the first authorization token includes the first legacy token, and wherein obtaining the first legacy token comprises extracting, from the first authorization token, the first legacy token.

17. The computing system of claim 13, wherein obtaining the first legacy token comprises:
sending, to the authorization server and based on the first API request, an indication of the first service and the first authorization token; and
receiving, from the authorization server, the first legacy token.

18. The computing system of claim 17, wherein the first legacy token is generated by the authorization server on demand and in response to receiving the indication of the first service and the first authorization token.

19. The computing system of claim 13, wherein the memory stores additional computer readable instructions that, when executed by the one or more processors, cause the computing system to:
identifying, based on a service configuration corresponding to the first service, that all legacy users of the first service have transitioned to the new authentication scheme; and
causing, for the first service, a reconfiguration from the legacy authentication scheme to the new authentication scheme.

20. One or more non-transitory computer-readable media storing instructions that, when executed by a computing system comprising at least one processor, a communication interface, and memory, cause the computing system to:
receive, from a first user device and at an API gateway, a first authorization token and a first application programming interface (API) call for a first service, wherein the first service is configured with a legacy authentication scheme, and wherein the first authorization token corresponds to a new authentication scheme, different than the legacy authentication scheme;
obtain, using the first authorization token and from an authorization server that generated the first authorization token, a first legacy token corresponding to the first service and the legacy authentication scheme;
forward, along with the first legacy token and to an API endpoint for the first service, the first API call;
receive, from the API endpoint for the first service, a first API response for the first API call; and
forward the first API response to the first user device.
